(19) United States
(12) Patent Application Publication
(10) Pub. No.: US 2007/0294007 A1
(43) Pub. Date: Dec. 20, 2007

(54) Active Front Steer Angle Sensor Failure Detection System and Method

(75) Inventor: Kerfegar K. Katrak, Fenton, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/424,248

(22) Filed: Jun. 15, 2006

(51) Int. Cl. B62D 6/00; G06F 19/00

(52) U.S. Cl. 701/41

(57) ABSTRACT

A sensor failure detection system as described herein can be deployed in an automotive active front steering control system. The sensor failure detection system identifies a failed sensor and its associated failure mode based upon an analysis of sensor state patterns, where a sensor state pattern represents the output for a plurality of sensors taken at one sensor position. A sensor failure is indicated in response to the detection of a first repeating state pattern over two adjacent sensor positions, and a second repeating state pattern over two other adjacent sensor positions.

### TECHNICAL FIELD

The present invention generally relates to active front steer control systems, and more particularly relates to sensor failure detection techniques.

### BACKGROUND

Vehicle steering is generally controlled by a driver hand wheel that directs the angle of the vehicle wheels used for steering. The movements of the driver hand wheel are transmitted to the vehicle wheels by mechanical linkages or electronic components. The vehicle wheels that change angle are usually in the front of the vehicle (front steering).

Active front steering (AFS) is a term referring to the use of electronic components to actively control the steering of a vehicle so as to enhance steering performance beyond that possible by only direct mechanical linkages. There are many possible ways to enhance steering performance; for example, steering can be adapted to the weather conditions, to the behavior and habits of the driver, provide orderly stopping if the driver loses control, enhance the driver hand wheel control by changing steering characteristics, or provide enhanced driver control in the event of a steering mechanism malfunction.

In an AFS system, the intended angle at the hand wheel and the actual angle at the front steering wheels are monitored by sensors; for example, Hall effect sensors. A Hall effect sensor is an electronic device that varies its output voltage in response to changes in magnetic field density. When a magnetic field is perpendicular to the surface of a sheet of conductive material, an electric field is created across the surface. For a given magnetic field, the distance from the magnet to the sheet can be determined. Using groups of sensors, the relative position of a known magnet can be determined. Hall effect sensors can be used to time the speed and position of wheels and control shafts. Due to their magnetic nature Hall effect sensors are non-contacting so they don't have wear from contact over time. Because they are non-contacting, Hall effect sensors are generally not affected by dust, dirt, mud, water, and oils so they are ideal for the generally dirty environment of automotive applications. A Hall effect sensor may have circuitry that allows the device to act in a high voltage/low voltage switch mode. Other binary devices that allow the sensors to act in a high voltage/low voltage switch mode may also be used to time the speed and position of the wheels and the control shafts, including, without limitation, transistors.

A primary concern is to insure that the sensors that monitor the active steering system are in proper working order. In one existing active steering system, there are three sensors (identified by the letters U, V, and W) that are used to determine the steering angle of the front steering wheels. Each sensor is either in a “High” state (for example, corresponding to a 12 volt output) or a “Low” state (for example, corresponding to a 0 volt output). The working order of the three sensors is determined by a diagnostic system. In order to confirm that the three angle sensors are working properly, existing diagnostic methods use patterns of the sensor High or Low states. For example, one sensor (U, V, or W) may fail by being stuck in either a “High” or “Low” state. The previous methods check for each of the three sensors stuck at “High” or “Low” for various sensor positions in a specified time loop for a specified number of consecutive samples (to insure that the potential failure detection condition is not transient), which can take an undesirably long time. This diagnostic time may not be quick enough for practical AFS applications, where immediate sensor failure detection is desirable.

Accordingly, it is desirable to design a new diagnostic method and system to reduce the diagnostic time for detecting AFS angle sensor failure. Other desirable features and characteristics of embodiments of the present invention will become apparent from the subsequent detailed description and the appended claims, taken in conjunction with the accompanying drawings and the foregoing technical field and background.

### BRIEF SUMMARY

A system according to an example embodiment of this invention provides a way to reduce the diagnostic time for detecting an AFS angle sensor failure. The system includes an AFS angle sensor failure state diagnostic monitoring process that can be utilized effectively in all vehicles capable of using an AFS system. By reducing the angle sensor monitoring system diagnostic time for detecting an angle sensor failure, this example embodiment provides the vehicle user with an effective and robust AFS system.

The example embodiment uses a method of detecting sensor failure in active steering angle sensors using detection of failure patterns. The AFS angle sensor failure monitoring system according to an example embodiment of the invention includes a plurality of angle sensors, each angle sensor being configured to indicate a plurality of states, and each angle sensor being configured to generate output for a plurality of angle sensor positions. The system monitors the states of the angle sensors at each angle sensor position. It may then detect a first repeating state pattern over two adjacent angle sensor positions and a second repeating state pattern over two adjacent angle sensor positions. If the first and the second repeating state patterns are detected to be unique patterns (described in detail below), the AFS angle sensor failure state diagnostic monitoring system may then indicate an angle sensor failure in response to the detecting step.

Using an embodiment of the new method allows an AFS angle sensor diagnostic to meet safety and security metrics because they are diagnosed prior to a lane departure so the driver has time to react. Further, this embodiment reduces the likelihood of false sensor failure detection by processing multiple sensor samples over a period of time. Additionally, this embodiment increases robustness for false failure by using six repeating state pattern combinations that indicate angle sensor failures, and by allowing individual failure diagnosis. For example, the individual failure diagnostic includes, but is not limited to, a diagnostic for a failure due to a single wire failure or a power failure. An embodiment of the invention also reduces the number of time loops required for a diagnostic by allowing the individual failure diagnosis for each angle sensor.

Other desirable features and characteristics of embodiments of the present invention will become apparent from the subsequent detailed description and the appended claims, taken in conjunction with the accompanying drawings and the foregoing technical field and background.

### BRIEF DESCRIPTION OF THE DRAWINGS

The present invention will hereinafter be described in conjunction with the following drawing figures, wherein like numerals denote like elements, and

FIG. 1 is a schematic representation of an AFS system according to an example embodiment of this invention;

FIG. 2 is a table of nominal state patterns that indicate no angle sensor failures;

FIG. 3 is a table of repeating state pattern combinations that indicate angle sensor failures for an example embodiment of the invention; and

FIG. 4 is a flowchart of an AFS failure state diagnostic monitoring process according to an example embodiment of this invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission protocols and that the system described herein is merely one example embodiment of the invention.

For the sake of brevity, conventional techniques related to signal processing, data transmission, AFS systems, Hall effect sensors, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

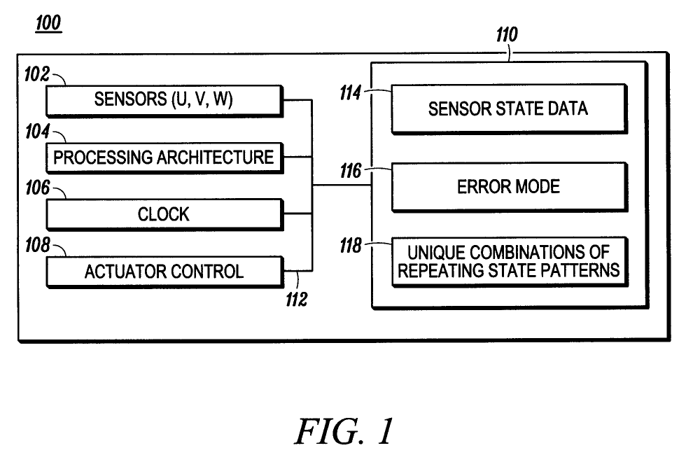

“Connected/Coupled”—The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 1 depicts one example arrangement of elements, additional intervening elements, devices, features, or components may be present in an embodiment of the invention (assuming that the functionality of the system is not adversely affected).

A system configured in accordance with an example embodiment of the invention can detect failure of sensors by analyzing sensor state patterns corresponding to the output of the sensors. Such a system may be deployed in an AFS system to detect failure of the AFS actuator angle sensors. While an AFS angle sensor may be realized as a robust Hall effect sensor, an AFS angle sensor failure may occur due to vibration, wear and tear, excessive voltage, or a myriad of other sources. A primary concern is to insure that the sensors that monitor the active steering system are in proper working order. A system as described herein can be implemented as a diagnostic system for the sensors.

The example system described herein utilizes three sensors, however, other embodiments of the invention may utilize more or less than three. In an automotive AFS application, the sensors measure the angle of an actuator that ultimately influences the steering angle of the front steering wheels. In this example, each sensor can assume one of two states: a “High” state, which usually corresponds to a relatively high voltage; or a “Low” state, which usually corresponds to a relatively low voltage. When one of these sensors fails, it becomes stuck in either a “High” or “Low” state.

The system described herein provides a technique that allows the AFS failure state diagnostic time to meet safety and security metrics because they are diagnosed prior to a lane departure so the driver has time to react, while increasing robustness by detecting two different combinations of repeating state patterns over two adjacent angle sensor positions for a single failure. An embodiment of the invention may be implemented on a single processor or alternatively, on a plurality of system processors in an AFS module to provide independent and redundant processing.

FIG. 1 is a schematic representation of an AFS 100 having an AFS that is suitably configured to perform failure diagnostic monitoring processes according to an example embodiment of the invention. The various block modules depicted in FIG. 1 may be realized in any number of physical components or modules located throughout the AFS 100 and/or the vehicle. A practical AFS 100 may include a number of electrical control units (ECUs), computer systems, and components other than those shown in FIG. 1. Conventional subsystems, features, and aspects of AFS 100 will not be described in detail herein.

AFS 100 generally includes a plurality of sensors 102, a processing architecture 104, a clock 106, an actuator control 108, and a suitable amount of memory 110. These elements may communicate with one another as needed via a communication bus 112 or other suitable interconnection architecture or arrangement. In this embodiment, the processing architecture 104, clock 106, and memory 110 support the AFS failure state diagnostic monitoring process described in more detail below.

In the example embodiment, the sensors 102 are devices for measuring the AFS actuator angle, and the sensor output is utilized as feedback by the AFS to control the actuator angle control signals. In turn, the AFS actuator angle influences the steering angle position of the vehicle wheels. In practice, Hall effect angle sensors may be located between a wave motion generator, a flexible gear and a stator gear inside an AFS motor in the vehicle or other locations not shown in FIG. 1.

Each of the sensors 102 is configured to generate output for a plurality of sensor positions, and each of the sensors 102 is configured to indicate a plurality of output states. According to one embodiment of this invention, sensors 102 comprise three Hall effect angle sensors (identified as sensors U, V, and W), wherein each angle sensor generates angle sensor state data corresponding to each angle sensor position. In this example, each sensor 102 indicates a high (H) or a low (L) state at each angle sensor position, and information or data indicative of the H or L state is processed by AFS 100 in the manner explained below. Thus, for a particular sensor position, the current states for the sensors 102 represent a state pattern. For example, a state pattern at a first sensor position may be (U=H, V=L; W=L), a state pattern at a fifth sensor position may be (U=L, V=L, W=H), and so on.

In accordance with one practical embodiment of the invention, each sensor 102 is configured to indicate its respective state for a repeating sequence of sensor positions. For example, AFS system 100 may be implemented such that each sensor 102 can generate an output state at six different consecutive positions (e.g., positions one through six). After being sampled at position six, however, each sensor 102 “returns” to position one for sampling. Consequently, under normal operating conditions the sensors 102 generate a continuous sequence of outputs corresponding to a repeating loop for the sensor positions. Any two consecutive sensor positions are considered to be two adjacent sensor positions (for example, sensor positions three and four are adjacent to each other). Moreover, as used herein, the last sensor position and the first sensor position are considered to be two adjacent sensor positions. The sensor positions one to six are located on the AFS actuator.

As mentioned previously, when a sensor 102 fails, it typically results in a permanent state indication. In this example, a sensor failure results in a permanent High state indication or a permanent Low state indication for the failed sensor. In other words, regardless of the sensor position, the failed sensor will always indicate the same output state (High or Low, depending upon the failure mode, the failure cause, the failure conditions, etc.).

The processing architecture 104 is generally a logical processing device that is configured to perform the operations described in detail herein. In practice, processing architecture 104 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

In the example embodiment, the processing architecture 104 is configured to monitor the AFS failure state diagnostic process. Processing architecture 104 monitors the states of the angle sensors at each angle sensor position. Briefly, the processing architecture 104 is suitably configured to detect a first repeating state pattern over two adjacent sensor positions and a second repeating state pattern over two adjacent sensor positions. In the example embodiment, the combination of the two repeating state patterns is unique within the context of AFS 100, which enables the processing architecture 104 to detect and identify a failure mode corresponding to a specific sensor failure. In this regard, a permanent state indication generated by a failed sensor (i.e., always High or always Low) results in one of these unique combinations of repeating state patterns. Thus, the detection of the first and second repeating state patterns is responsive to a permanent state indication. Moreover, the processing architecture 104 can indicate a sensor failure in response to the detection of the first and second repeating state patterns. The unique repeating state patterns and the error mode will be described in detail below.

Clock 106 is coupled to the processor 104 and is configured to synchronize, monitor, and control the number of time loops required for the AFS 100 failure state diagnostic monitoring process. Clock 104 may also be utilized for other operations necessary to support the functionality of AFS 100.

The actuator control 108 controls the actuator angle for the AFS 100. The actuator control 108 may be located at the flexible gear inside the AFS motor or other locations not shown in FIG. 1.

The memory 110 is a data storage area that is formatted to support the operation of AFS 100. Memory 110 is coupled to the sensors 102 and has sufficient capacity to accommodate the AFS failure state diagnostic monitoring process. Memory 110 is configured to store sensor state data 114 generated by the sensors 102 at the various sensor positions, the error modes 116, and the unique combinations of repeating state patterns 118. Memory 110 may be realized as RAM memory, flash memory, registers, a hard disk, a removable disk, or any other forms of storage medium known in the art.

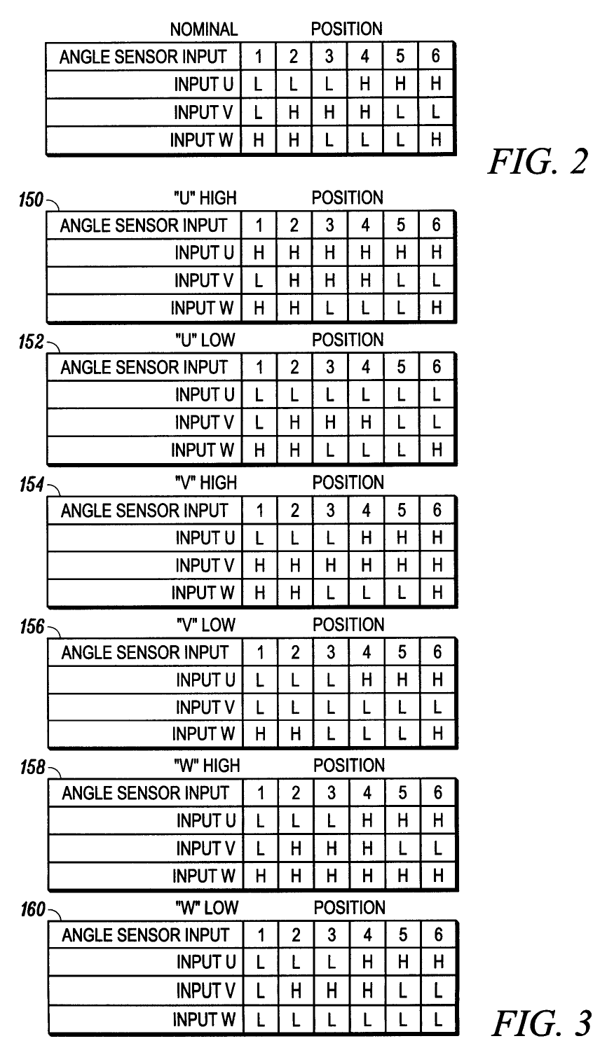

In one example embodiment of this invention, an AFS angle sensor permanent failure state is either a “High” or “Low” fault for all of the angle sensor positions. There are six angle sensor positions for each angle sensor corresponding to rotation of an AFS actuator. When the angle sensors are functioning normally (no failure) there are six nominal sensor positions for each angle sensor as shown in FIG. 2. Notably, there are three contiguous “High” states and three contiguous “Low” states in the nominal sensor positions for each angle sensor (U, V, or W), any other combinations of state patterns may be an indication of a sensor failure. For example, as mentioned above, a sensor failure is detected when a unique combination of two repeating state failure patterns occur. The system detects a sensor failure when two repeating state patterns occur over two adjacent angle sensor positions in one designated time loop (6 ms in this example). Example combinations of repeating state patterns are described in detail below with reference to FIG. 3. In particular, FIG. 3 identifies the conditions associated with a “U-Sensor-High” failure mode 150, a “U-Sensor-Low” failure mode 152, a “V-Sensor-High” failure mode 154, a “V-Sensor-Low” failure mode 156, a “W-Sensor-High” failure mode 158, and a “W-Sensor-Low” failure mode 160.

The following pairs of repeating state patterns are unique for each sensor failure mode and do not overlap between failures. For example:

For the “U-Sensor-High” failure mode 150, the first repeating state pattern is (U=H; V=H; W=L) and the second repeating state pattern is (U=H; V=L; W=H). The first repeating state pattern occurs over adjacent sensor positions three and four. Notably, the second repeating state pattern occurs over “adjacent” sensor positions six and one.

For the “U-Sensor-Low” failure mode 152, the first repeating state pattern is (U=L; V=H; W=L) and the second repeating state pattern is (U=L; V=L; W=H). The first repeating state pattern occurs over adjacent sensor positions three and four. Notably, the second repeating state pattern occurs over “adjacent” sensor positions six and one.

For the “V-Sensor-High” failure mode 154, the first repeating state pattern is (U=L; V=H; W=H) and the second repeating state pattern is (U=H; V=H; W=L). The first repeating state pattern occurs over adjacent sensor positions one and two, and the second repeating state pattern occurs over adjacent sensor positions four and five.

For the “V-Sensor-Low” failure mode 156, the first repeating state pattern is (U=L; V=L; W=H) and the second repeating state pattern is (U=H; V=L; W=L). The first repeating state pattern occurs over adjacent sensor positions one and two, and the second repeating state pattern occurs over adjacent sensor positions four and five.

For the “W-Sensor-High” failure mode 158, the first repeating state pattern is (U=L; V=H; W=H) and the second repeating state pattern is (U=H; V=L; W=H). The first repeating state pattern occurs over adjacent sensor positions two and three, and the second repeating state pattern occurs over adjacent sensor positions five and six.

For the “W-Sensor-Low” failure mode 160, the first repeating state pattern is (U=L; V=H; W=L) and the second repeating state pattern is (U=H; V=L; W=L). The first repeating state pattern occurs over adjacent sensor positions two and three, and the second repeating state pattern occurs over adjacent sensor positions five and six.

Referring to the “U-Sensor-High” failure mode 150, “Input U” is high (H) for all six sensor positions, thus the U sensor is in a permanent High state. The V and W sensors, however, are in their nominal state (see FIG. 2) and are functioning normally. According to an example embodiment of this invention, if the AFS failure state diagnostic monitoring process detects these two repeating state patterns in a single loop, the process will detect an error mode. More particularly, the process can identify a failure mode for one of the sensors, namely, the U sensor in this example. Even more specifically, the process can analyze the repeating state patterns to determine whether the potentially failed sensor is in a permanent High state or a permanent Low state (in this example, the U sensor is in a permanent High state). The remaining sensor failure modes shown in FIG. 3 can be similarly construed.

As depicted in FIG. 3, one repeating state pattern may be associated with more than one sensor failure mode. For example, the repeating state pattern (U=H; V=H; W=L) appears for both the “U-Sensor-High” failure mode 150 and the “V-Sensor-High” failure mode 154. Each combination of two repeating state patterns, however, is unique in the context of the AFS. Moreover, in the example embodiment the first and second repeating state patterns are different for any given failure mode. This uniqueness enables the AFS to identify the failed sensor and whether that sensor has failed in a High state or a Low state.

Notably, if the AFS system includes N sensors, there are 2N state positions. A unique arrangement of the first and the second repeating state patterns corresponds to 2N possible error modes for each of the High (sensor-High) or Low (sensor-Low) sensor states.

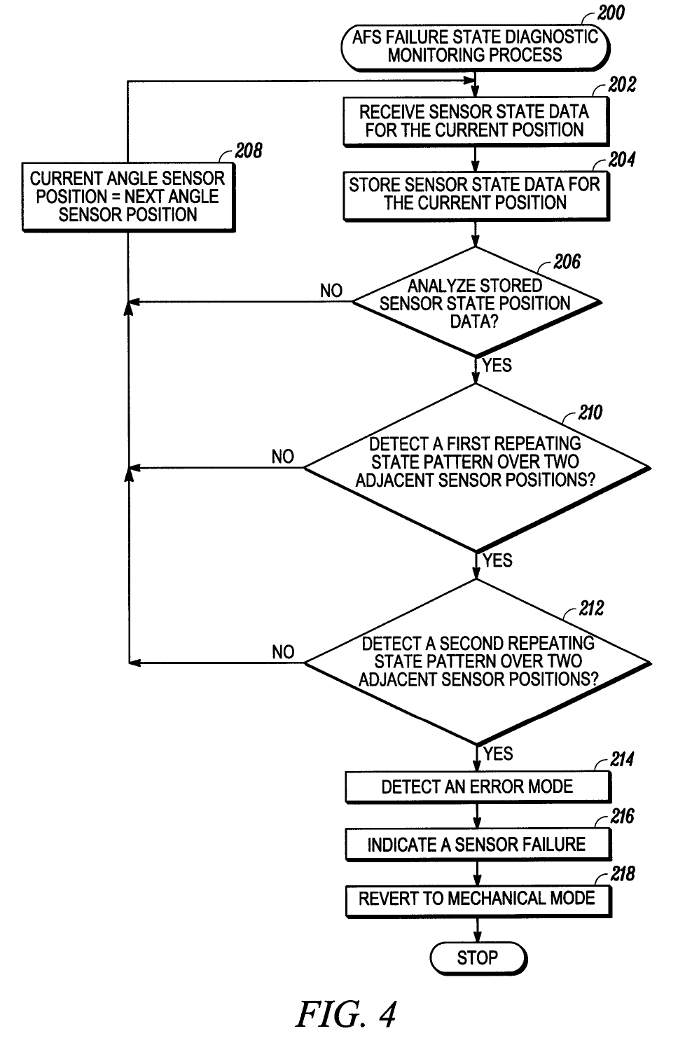

FIG. 4 contains a flow chart of an AFS failure state diagnostic monitoring process 200. The AFS failure state diagnostic monitoring process 200 operates according to an example embodiment of the invention. The various tasks performed in connection with process 200 may be performed by software, hardware, firmware, or any combination thereof. For illustrative purposes, the following description of process 200 may refer to elements mentioned above in connection with FIG. 1 and FIG. 4. In practical embodiments, portions of process 200 may be performed by different elements of the described system, e.g., sensor 102, processing architecture 104, actuator control 108, or memory 110. It should be appreciated that process 200 may include any number of additional or alternative tasks, the tasks shown in FIG. 4 need not be performed in the illustrated order, and process 200 may be incorporated into a more comprehensive procedure or process having additional functionality not described in detail herein.

AFS failure state diagnostic monitoring process 200 may monitor the states of the sensors at each sensor position. Thus, process 200 may begin by receiving sensor state data for the current sensor position (task 202). In one example embodiment of this invention, the current sensor position state data is generated by the sensors (U, V, W), and the data received during an iteration of task 202 represents a sensor state pattern as described above. In practice, the sensor state data for a sensor may represent a permanent High state or a permanent Low state. The sensor state data for the current sensor position may be stored (task 204) in an appropriate manner for subsequent analysis.

Process 200 may then decide to analyze the stored sensor state data (query task 206) for occurrences of repeating state patterns. If process 200 determines that it need not analyze the stored sensor data at this time, then process 200 may update the current sensor position (task 208) and lead back to task 202 to obtain the sensor state data for the next sensor position. If, however, process 200 decides to analyze the stored sensor state data, then it may proceed to a query task 210. In practice, the processing architecture of the AFS system may read the stored sensor position data from its memory.

Query task 210 is associated with the detection of a first repeating state pattern over two adjacent sensor positions. If process 200 does not detect a first repeating state pattern, then process 200 may update the current sensor position (task 208) and lead back to task 202. If process 200 detects a first repeating state pattern, then process 200 may proceed to a query task 212. Query task 212 is associated with the detection of a second repeating state pattern over two adjacent sensor positions. In this example, the first pair of adjacent sensor positions and the second pair of adjacent sensor positions are different. If process 200 does not detect a second repeating state pattern, process 200 may update the current sensor position (task 208) and lead back to task 202.

If process 200 detects a second repeating state pattern, it may then detect, indicate, or identify an error mode (task 214) corresponding to a sensor failure. Task 214 may be a simple indication that a sensor has failed, regardless of the failure mode and without identifying the failed sensor. Alternatively, task 214 may be an indication that a sensor is permanently indicating a High or a Low state and/or an identification of the failed sensor. In this regard, process 200 may analyze the first and the second repeating state patterns to identify a potentially failed sensor from the plurality of sensors and analyze the first and the second repeating state patterns to determine whether the potentially failed sensor is in a permanent first state (High) or a permanent second state (Low). In practice, process 200 may detect any of the possible error modes corresponding to a specific sensor (U, V, or W) failure and proceed to a task 216 to indicate the specific sensor failure.

In an automotive application, process 200 may then disengage the AFS control mode and revert to a mechanical front steer mode (task 218). Process 200 may also generate a warning or a service indicator that informs the driver of a potential problem with the AFS. Thereafter, AFS failure state diagnostic monitoring process 200 may stop executing.

An AFS failure state diagnostic monitoring process according to an example embodiment of the invention reduces the time required for a practical diagnostic determination by reducing the number of tests required for a failure diagnosis for each sensor (U, V, or W). When one sensor fails either High or Low, the unique combination of repeating state patterns that occur over two adjacent angle sensor positions for a given sensor can be quickly measured due to the fact that four sensor positions are analyzed in each processing loop. Further, this embodiment increases robustness for detecting false failures of any single sensor.

In an example embodiment of this invention, when one or more of the sensors (U, V, or W) fail either “High” or “Low”, the two different unique combinations of repeating state failure patterns that occur over two adjacent angle sensor positions for a given sensor is measured for the sensors (U, V, or W) “High” or “Low” conditions, collectively, in about 6 ms interval of four samples (in this example, each sample measures about 30 of each of the unique combinations of the repeating state failure patterns) per diagnostic time loop. There are about seven diagnostic time loops equal to about 42 ms plus one loop of about 2 ms control loop jitter (a control loop jitter is an additional control loop execution that may occur, for example, when a sensor failure is detected) which completes in about 44 ms. This may be lowered to about six diagnostic time loops resulting in a diagnostic time of about 36 ms plus one loop of about 2 ms control loop jitter yielding about 38 ms. Using the system and method as described in the example embodiment of this invention allows an AFS angle sensor diagnostic to meet security metrics because they are dignost prior to a lane departure such that the driver has time to react.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for detecting an active front steer angle sensor failure in a system having a plurality of angle sensors, each angle sensor being configured to indicate a plurality of states, and each angle sensor being configured to generate output for a plurality of angle sensor positions, the method comprising:
monitoring the states of the angle sensors at each angle sensor position;
detecting a first repeating state pattern over two adjacent angle sensor positions, and a second repeating state pattern over two adjacent angle sensor positions; and
indicating an angle sensor failure in response to the detecting step.

2. A method according to claim 1, further comprising detecting an error mode corresponding to the angle sensor failure.

3. A method according to claim 2, further comprising identifying a failure mode for one of the plurality of angle sensors, wherein the first and second repeating state patterns in combination uniquely identifies the failure mode.

4. A method according to claim 3, wherein detecting an error mode comprises:
analyzing the first and second repeating state patterns to identify a potentially failed angle sensor from the plurality of angle sensors; and
analyzing the first and second repeating state patterns to determine whether the potentially failed angle sensor is in a permanent first state or a permanent second state.

5. A method according to claim 2, wherein:
the plurality of angle sensors includes N angle sensors; and
the N angle sensors having 2N possible error modes corresponding to each state of each angle sensor.

6. A method according to claim 1, further comprising reverting to a mechanical front steer mode in response to the detecting step.

7. A method according to claim 1, further comprising:
receiving, from the angle sensors, angle sensor state data corresponding to the angle sensor positions; and
storing the angle sensor state data to obtain stored angle sensor state data; wherein
the detecting step accesses the stored angle sensor state data.

8. A method according to claim 1, wherein a state pattern represents current states for the plurality of angle sensors taken at one of the plurality of angle sensor positions.

9. A method according to claim 1, wherein the first and the second repeating state patterns are different.

10. A method according to claim 1, wherein each angle sensor is configured to indicate its respective state for a repeating sequence of the plurality of angle sensor positions.

11. A method according to claim 1, wherein:
each angle sensor is configured to indicate a first state or a second state; and
angle sensor failure results in a permanent first state indication or a permanent second state indication generated by a failed angle sensor.

12. A method for detecting sensor failure in a system having a plurality of sensors, each sensor having a first output state and a second output state, and each sensor being configured to indicate either the first output state or the second output state at each of a plurality of sensor positions, the method comprising:
receiving sensor state data corresponding to the sensor positions;
storing the sensor state data to obtain stored sensor position data;
analyzing the stored sensor position data for occurrences of repeating state patterns; and
indicating a sensor failure if the analyzing step detects a first repeating state pattern over two adjacent angle sensor positions, and a second repeating state pattern over two adjacent angle sensor positions.

13. A method according to claim 12, wherein:
the plurality of sensors includes N sensors; and
the N sensors have 2N possible error modes corresponding to each output state of each sensor.

14. A method according to claim 12, wherein each sensor is configured to generate its respective output state for a repeating sequence of the plurality of sensor positions.

15. A method according to claim 14, wherein the first repeating state pattern corresponds to a state pattern for a last sensor position of the repeating sequence combined with the state pattern for a first sensor position of the repeating sequence.

16. A method according to claim 12, wherein a state pattern represents current states for the plurality of sensors taken at one of the plurality of sensor positions.

17. A method according to claim 12, wherein the first and the second repeating state patterns are different.

18. A system for detecting sensor failure, comprising:
a plurality of sensors, each being configured to indicate a plurality of output states, and each being configured to generate output for a plurality of sensor positions;
a memory coupled to the sensors and configured to store sensor state data generated by the sensors at the sensor positions; and
a processing architecture coupled to the memory and having processing logic configured to:
detect a first repeating state pattern over two adjacent sensor positions, and a second repeating state pattern over two adjacent sensor positions; and
indicate a sensor failure in response to detection of the first and second repeating patterns.

19. A system according to claim 18, the processing architecture being further configured to identify a failure mode for one of the plurality of sensors, wherein the first and second repeating state patterns in combination uniquely identifies the failure mode.

20. A system according to claim 18, wherein:
each sensor is configured to indicate a first state or a second state;
sensor failure results in a permanent state indication by a failed sensor, the permanent state indication corresponding to the first state or the second state; and
the processing architecture is further configured to detect the first and second repeating state patterns in response to the permanent state indication.
